(19) United States
(12) Patent Application Publication
(10) Pub. No.: US 2002/0014959 A1
(43) Pub. Date: Feb. 7, 2002

(54) Automatic drum brake adjusting apparatus and drum brake having such an adjusting apparatus

(76) Inventors: Peter Johannes Ludtke, Remagen (DE); Frank Biebricher, Guckingen (DE); Franz Blaeser, Andernach (DE)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 09/966,992

(22) Filed: Sep. 28, 2001

Related U.S. Application Data
(63) Continuation of application No. PCT/EP00/02692, filed on Mar. 27, 2000.

(30) Foreign Application Priority Data
Apr. 1, 1999 (DE) 199 15 007.9

(51) Int. Cl. B60Q 1/00

(52) U.S. Cl. 340/454; 340/453

(57) ABSTRACT

A drum brake includes an automatic adjusting apparatus for compensating for the wear of friction linings and of a drum. To detect the wear of the drum brake, the adjusting apparatus includes a signalling device, which supplies a signal dependent upon an adjusting travel of the adjusting apparatus. The adjusting travel is generated by a variable length adjusting strut, which includes a pressure sleeve and a threaded rod, which is accommodated in the latter and is screwable by means of a pinion out of the pressure sleeve.

### BACKGROUND OF THE INVENTION

The invention relates to an automatic drum brake adjusting apparatus for compensating for friction lining and drum wear, comprising a signalling device, which supplies a signal dependent upon an adjusting travel. The invention further relates to a drum brake having such an adjusting apparatus.

EP 0 460 378 A2 describes a brake actuating apparatus having a brake adjusting device, which is used to maintain an approximately constant clearance between the brake shoes and a brake drum as well as to monitor brake lining wear. In this case, a first signal transmitter, which produces a signal corresponding to the travel during negotiation of the clearance, and a second signal transmitter, which produces a signal corresponding to the travel during adjustment, are provided. The signals may be electrically evaluated. The provision of two signal transmitters on the adjusting device is cost and labour intensive.

A drum brake having an automatic adjusting apparatus is known from DE 25 08 614 C2. The adjusting apparatus comprises a strut, which is variable in length and is disposed between a brake shoe and an actuating lever and held by spring action in abutment with the brake shoe. A ratchet lever is pivotally supported on the brake shoe and engages into a ratchet wheel rotatably supported on the strut. As the friction lining provided on the brake shoe wears, the ratchet lever turns the ratchet wheel and hence adjusts the length of the adjustable strut.

In EP 0 140 241 it is proposed to equip such a drum brake with a wear warning conductor, which is fastened in a plug made of elastic, electrically insulating plastics material to one end of a brake shoe. The wear warning conductor is laid in a loop around the plug in such a way that, during braking, it comes into contact with the brake drum when the friction lining is extensively but not completely worn away. Similar wear warning systems are known from U.S. Pat. No. 1,902,759, U.S. Pat. No. 2,146,357, U.S. Pat. No. 2,217,176 and DE 709 251. The aim of these known apparatuses is to determine when friction linings of the drum brakes of the vehicle need to be replaced or brake shoes need to be adjusted.

DE 709 251 and U.S. Pat. No. 2,182,554 disclose apparatuses, by means of which it is possible to identify whether all of the brakes are identically adjusted and hence may also be applied uniformly and simultaneously. DE 709 251, in this case, on the basis of the previously described principle of a sliding contact between a wear warning conductor and the brake drum provides that each drum brake is equipped with such a wear warning conductor. With each of the latter a lamp is associated and the simultaneous illumination of the lamps additionally indicates to the driver that all of the wear warning conductors are simultaneously coming to lie against the drum brake, i.e. that all brakes are simultaneously applied. U.S. Pat. No. 2,182,554 proposes to determine by means of a temperature-dependent resistor on each drum brake whether the drum brakes are heating up uniformly. In the event of non-uniform heating, non-uniform application of the brakes is inferred.

The function of brake systems is generally to decelerate a vehicle, keep its speed constant when travelling downhill and immobilize it for parking. During such braking operations the brakes at least of each individual axle are usually subject to uniform stress.

However, new brake systems have been assigned additional functions. For example, to prevent locking of the wheels (antilock control) and slipping of the wheels of an axle provided with a differential gear (traction control), individual wheels of the vehicle are to be braked. Similarly, to stabilize the driving state (vehicle dynamics control), individual wheels of the vehicle have to be braked. Thus, during such braking operations individual brakes of the brake system are subject to widely differing degrees of stress and hence to differing degrees of wear. The difference in the degree of wear of the brakes is accentuated by the fact that in modern brake systems, such as e.g. an electrohydraulic brake, extremely high and, at the same time, widely fluctuating braking forces may be summoned up. The wear of the friction linings may therefore vary considerably.

Furthermore, in modem brake systems new, particularly lightweight materials are being used, which are however susceptible to wear and relatively expensive. For example, light metal alloys and/or light metal composites are being used for brake drums. The surface of such materials may easily be damaged under the action of metal friction (metal on metal), making early detection of worn friction linings particularly essential.

### SUMMARY OF THE INVENTION

This invention is to provide an automatic drum brake adjusting apparatus, which makes accurate identification of friction lining wear possible in a simple manner.

To achieve this, the invention provides an automatic drum brake adjusting apparatus of the type described initially, in which a variable-length adjusting strut is used, which comprises a sleeve and a threaded rod, which is accommodated in the latter and is screwable out of the sleeve by means of a pinion. Such an adjusting apparatus has, with regard to the signal detection according to the invention, the advantage that by means of a mechanism comprising a threaded rod and a sleeve the required adjusting travel is sensitively adjustable so that an accurate signal is generated.

The signal generated by the signalling device is advantageously brought to the attention of a vehicle driver visually by means of a warning lamp and/or acoustically by means of a warning sound. This is possible in a particularly simple manner and may, for example, alert the vehicle driver to the fact that the drum brakes require servicing. It is however also possible to process the signal in a control unit of the brake system (ABS, TCS, brake-by-wire) and, in this case, take into account a change of the signal during predetermined periods of time. An extreme change of the signal during such a period indicates particularly high brake wear within a short time and high stressing of the brake. By virtue of appropriate countersteering an overstressing of individual brakes may be avoided.

According to a particularly simple form of construction of the adjusting apparatus according to the invention, the threaded rod after a predetermined adjusting travel actuates a switch, which immediately triggers an (optical and/or acoustic) warning signal.

To achieve an arrangement of the switch, which is space saving and protected from environmental influences, the switch is preferably disposed in the sleeve.

Since a drum brake—as a result of being provided immediately adjacent to the wheels—is exposed to high loads resulting from impacts, water and dust, the signalling device should be of a particularly rugged design. This may be achieved, for example, by means of a switch with a purely mechanical switching contact.

According to another refinement, the switch takes the form of an electromagnetic, inductive or capacitive switch. Thus, on the one hand, an influencing of the adjusting apparatus by the switch is ruled out and, on the other hand, the time characteristic of the adjusted travel may be determined in a particularly advantageous manner. A friction lining with a high degree of wear within a short time indicates, for example, overheating of the drum brake.

According to one form of construction a drum brake, in which the adjusting apparatus according to the invention is used, is developed in such a way that at least one leading brake shoe is provided with an additional signalling device for indicating wear of the friction lining. It is then possible to obtain two redundant signals, which with an extremely high degree of certainty indicate a wear of the drum brake. The signal of the signalling device on the adjusting apparatus is dependent upon the friction lining and drum wear, while the signal of the additional signalling device is dependent exclusively upon the friction lining wear. From the difference of the two signals conclusions may therefore be drawn about the wear of the drum alone.

In a refinement, the drum brake is developed in such a way that a conductor leading to the signalling device extends inside the resetting springs, which reset the brake shoes. Such a conductor may moreover extend through an opening in an anchor plate of the drum brake, which opening is disposed axially symmetrically relative to another opening, which is provided for penetration of a hand brake cable, wherein a component of a plug-in connector is preferably fastened in the other opening. The drum brake may moreover be developed in that the conductor extends through an opening in a dome of the anchor plate, wherein a plug-in connector is preferably fastened by means of a tubular rivet in the opening. In this manner, the attachment of the conductors is of a particularly secure and durable design.

The operating ability of the signalling devices is checked in a particularly advantageous manner in that a conductor leading to the signalling device is closed-circuit-protected.

The additional signalling device is fastened to a brake shoe preferably by way of a lock washer, spreader arms or a lock nut. Thus, it is extremely easy to assemble and disassemble.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a front view of a form of construction of a drum brake according to the present invention.

FIG. 2 is a view taken along the section II-II in FIG. 1.

FIG. 3 is a view taken along the section III-III in FIG. 1.

FIG. 4 is a partial sectional view of a first form of construction of an adjusting apparatus according to the invention in a position such as is adopted with new friction linings.

FIG. 5 is a view of the adjusting apparatus in FIG. 4 in a position such as is adopted with worn friction linings.

FIG. 6 is a partial sectional view of a second form of construction of an adjusting apparatus according to the invention with a proximity switch.

FIG. 7 is a first form of construction of the proximity switch of FIG. 6 to an enlarged scale.

FIG. 8 is a second form of construction of the proximity switch of FIG. 6 to an enlarged scale.

FIG. 9 is a third form of construction of the proximity switch of FIG. 6 to an enlarged scale.

FIG. 10 is a diagram of an adjusting apparatus according to the invention.

FIG. 11 is a first embodiment of an additional signalling device in a section through a brake shoe.

FIG. 12 is a second form of construction of an additional signalling device in a section through a brake shoe.

FIG. 13 is a third form of construction of an additional signalling device in a section through a brake shoe.

### DETAILED DESCRIPTION OF THE PREFERRED EMBODIMENTS

Referring now to the drawings, FIG. 1 shows a drum brake 10 having two brake shoes, namely a left, leading brake shoe 12 and a right, trailing brake shoe 14, which are fastened to an anchor plate 16 by means of holding-down devices 18 and 20 respectively. The brake shoes 12 and 14 are supported by their, in the drawing, bottom ends 22 and 24 against a dome 26, which projects out of the drawing plane away from the anchor plate 16. A hydraulic wheel brake cylinder 32 is disposed in a known manner between the top ends 28 and 30 of the two brake shoes 12 and 14. The two brake shoes 12 and 14 are radially surrounded by an, in section, circular brake drum 34. Situated in the wheel brake cylinder 32 are two pistons (not shown) which, when hydraulic fluid is supplied, spread the brake shoes 12 and 14 apart from one another and press them against the inside of the brake drum 34.

Besides the hydraulic actuation, which is provided for service brake operations, the drum brake 10 may also be used as a parking brake. To this end, a hand brake lever 36 (partially illustrated by dashes) is provided, which is mounted rotatably in a bearing 38 in the top end region of the right brake shoe 14.

For adjusting the brake shoes 12 and 14 in the event of friction lining wear an adjusting apparatus 40 is provided, which comprises an adjusting strut 41, which extends in the top region of the drum brake 10 between the two brake shoes 12 and 14. The adjusting strut 41 comprises a pressure sleeve 42, a pressure rod 44 accommodated in the latter and an adjusting pinion 46 screwed onto the pressure rod. Underneath the bearing 38 the hand brake lever 36 is coupled by the adjusting strut 41 to the left brake shoe 12. The free end of the hand brake lever 36 is connected to a hand brake cable 48. When the latter is pulled to the left, the hand brake lever 36 swivels about the bearing 38 and, in so doing, via the adjusting strut 41 presses the brake shoes 12 and 14 against the drum 34. The braking torque is introduced via the dome 26 into the anchor plate 16 and from the latter into the vehicle axle.

Disposed in the top and bottom end region of the brake shoes 12 and 14 are brake shoe retracting springs 52 and 50, which bias the brake shoes away from the brake drum so that the brake shoes 12 and 14, after release of the brake, return into their inoperative position. In the inoperative position, the spring forces of the retracting springs 50 and 52 are taken up by the adjusting strut 41 as well as by the dome 26.

A resetting spring 54 wound spirally around the hand brake cable 48 assists the swivelling of the hand brake lever 36 back into the inoperative position until the latter abuts a stop 56 on a radially inwardly extending web plate 58 of the right brake shoe 14.

Fastened to the outside of each of the brake shoes 12 and 14 is a friction lining 60 and 62, which upon actuation of the brake is moved towards the drum 34 and pressed against the inside of the latter. The brake shoes 12 and 14 in this case swivel about the supporting surfaces of the dome 26. The adjusting strut 41 is therefore relieved of the retraction force of the top brake shoe retracting spring 52 and the distance between the supporting surfaces of the adjusting strut 41 against the web plate 58 of the right brake shoe 14 (or the stop face on the hand brake lever 36) and a web plate 64 of the left brake shoe 12 increases.

A two-armed adjusting lever 66, which is likewise part of the adjusting apparatus 40, is pivotally supported on the web plate 64 by means of a clamping sleeve 68, which serves as a bearing and is pressed into the web plate. The adjusting lever 66 is supported by a shorter left lever arm 70 against the pressure rod 44, while a right, longer lever arm 72 engages into a saw tooth system 74 of the adjusting pinion 46. An adjusting spring 75 is disposed between the adjusting lever 66 and the bottom region of the web plate 64 and pulls the adjusting lever 66 downwards. The adjusting spring 75 therefore constantly exerts on the adjusting lever 66 a torque acting in clockwise direction around the clamping sleeve 68.

When the distance between the supporting surfaces of the adjusting strut 41 against the web plates 58 and 64 increases, the adjusting lever 66 may swivel about the clamping sleeve 68. The right lever arm 72 in this case rotates the adjusting pinion 46, which screws the pressure rod 44 out of the pressure sleeve 42. The pressure rod 44 is therefore fixed in a position of further withdrawal relative to the pressure sleeve 42. After release of the brake and resetting of the brake shoes 12 and 14, the adjusting lever 66 is also swivelled back into the original position. The adjusting lever 66 in this case slides in accordance with the extent of the previously executed swivelling motion back over the saw tooth system 74 of the adjusting pinion 46 and latches in behind a tooth of the saw tooth system 74. A full cycle of an adjusting motion at the adjusting strut 41 is thereby completed.

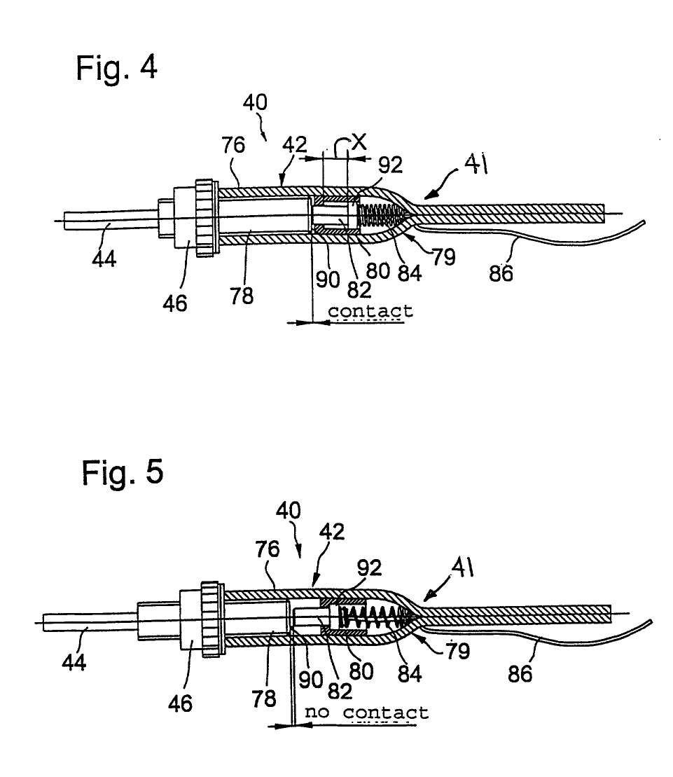

FIGS. 4 and 5 show an enlarged view of the adjusting strut 41. The adjusting strut 41 comprises the pressure sleeve 42 having a tubular portion 76, into which the pressure rod 44 projects with a part of a threaded rod 78. The adjusting pinion 46 is screwed on the threaded rod 78 until it comes into abutment with the pressure sleeve 42. Clamping forces, which act upon the ends of the adjusting strut 41, are therefore transmitted via the tubular portion 76 of the pressure sleeve 42 to the adjusting pinion 46 and from the latter to the threaded rod 78 of the pressure rod 44.

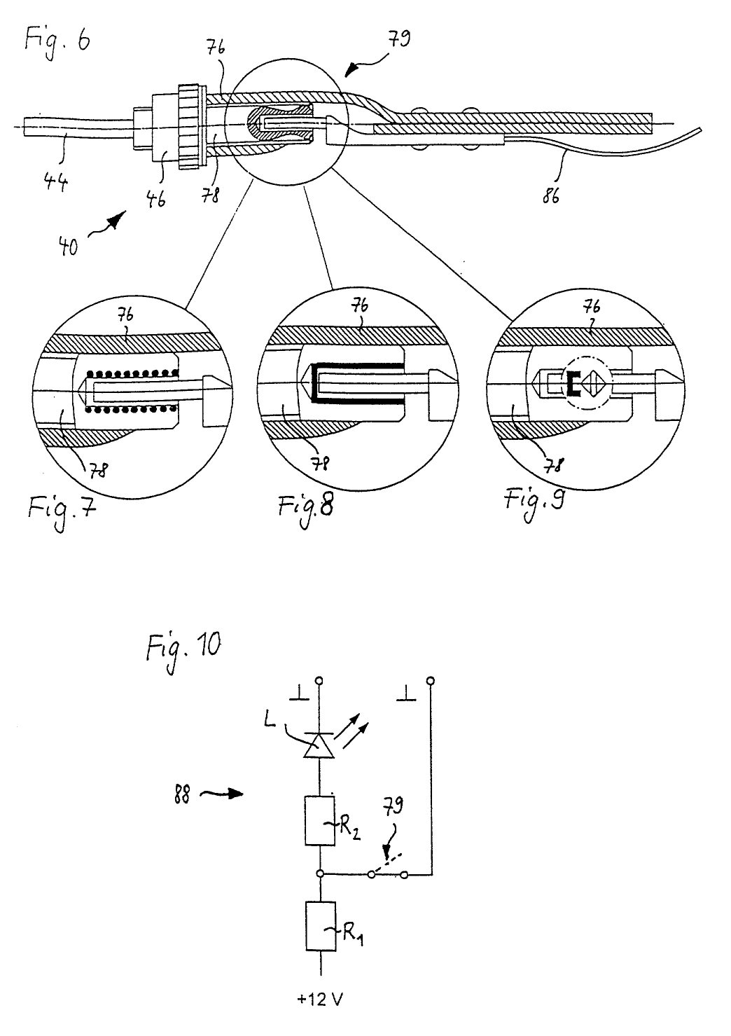

Disposed on the base in the tubular portion 76 of the pressure sleeve 42 is a switch 79 comprising an insulating sleeve 80, in which extends an electrically conducting contact pin 82 biased by means of a compression spring 84. An electric line 86 connects the contact pin 82 to an indicating apparatus (not shown), which may produce a warning sound or a warning light, or to a circuit arrangement 88, which is described below and illustrated in FIG. 10.

The compression spring 84 may be made of electrically insulating material but may alternatively take the form of a metal wire spring if additional insulation is provided between the contact pin 82 and the base of the tubular portion 76. Alternatively, an insulating disk may be inserted between the compression spring 84 and the contact pin 82, or a head 92 of the contact pin 82 is made of insulating material.

FIG. 4 shows the state with new friction linings 60 and 62. The contact pin 82 under the action of the compression spring 84 rests against the end face 90 of the threaded rod 78 disposed in the tubular portion 76. An electric monitoring current flows through the line 86, the contact pin 82, the end face 90, the pressure rod 44, the brake shoes 12 and 14 as well as the anchor plate 16.

As a result of the previously described rotation of the adjusting pinion 46 the pressure rod 44 is moved out of the pressure sleeve 42 to generate an adjusting travel. With increasing wear of the friction linings 60 and 62 the end face 90 of the pressure rod 44 is moved further and further out of the pressure sleeve 42 until the contact pin 82 has negotiated a distance X and the head 92 rests against the base of the insulating sleeve 80.

Upon yet further wear of the friction linings 60 and 62 the end face 90 of the pressure rod 44 distances itself from the contact pin 82 (FIG. 5) and the monitoring current is interrupted.

FIG. 10 shows the circuit arrangement 88 which, upon interruption of the monitoring current, actuates an active warning lamp. The monitoring current flows from a voltage source with a 12 V output voltage, e.g. a vehicle battery, via a series resistor RI, which has a resistance of e.g. 330 ohms. The switch 79, which is shown in a closed state in FIG. 10, connects the circuit with low resistance to a ground terminal. An interruption of the switch 79 (shown by dashes) has the effect that the current is now conducted via a resistor R2, which has a resistance of e.g. 510 ohms, and an active warning lamp L to ground. The signal triggered by the wear of the friction linings 60 and 62 therefore leads to illumination of the warning lamp L.

The circuit arrangement may also be designed in such a way that just a single interruption of the monitoring current leads to constant illumination of the warning lamp.

Via the length of the contact pin 82 the travel X of the switch 79 and hence the admissible wear of the friction linings 60 and 62 as well as of the drum 34 is definable. The sleeve 80 may, for such purpose, be pressed to a predetermined depth into the pressure sleeve 42.

As contact pin 82 and compression spring 84 in the embodiment described above it is possible to provide a brush sufficiently known from the field of electric motor construction as well as generator construction, a spring-guided sliding contact made of graphite, e.g. natural graphite, metal graphite or electrographite, which effects the transfer of current to a collector or to a slipring.

In further forms of construction the switch 79 takes the form of a proximity switch. FIGS. 6 to 9 show three examples thereof. FIG. 7 shows an inductive, FIG. 8 a capacitive and FIG. 9 a magnetic force-actuated sampling of the adjusting travel.

In such forms of construction it is further provided that an additional signalling device 94 is disposed on one of the friction linings of the drum brake. As is shown in FIG. 1, the additional signalling device 94 is let into the friction lining 60 in the bottom region of the leading brake shoe 12.

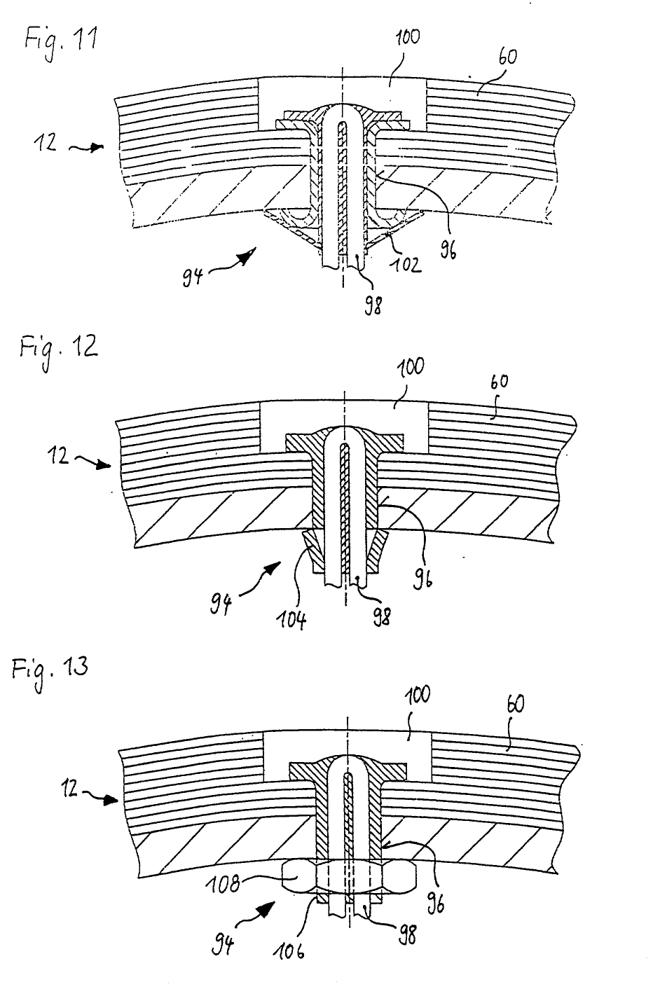

FIGS. 11 to 13 show details of forms of construction of such an additional signalling device 94. The signalling device 94 is inserted into a cavity of a rivet shank 96, such as is provided for a lining rivet, and comprises a wire loop 98 embedded in a plastics material. In a known manner, the wire loop 98 projects into a recess 100 of the friction lining 60 so that, in the event of wear of the friction lining 60, the wire loop 98 is cut through and so a signal may be supplied to a circuit arrangement 88.

The additional signalling device 94 may be fastened to the brake shoe 12 in various ways. The additional signalling device 94 illustrated in FIG. 11 is pressed into the cavity of the rivet shank 96, flanged and additionally fastened by means of a lock washer 102. The additional signalling device 94 illustrated in FIG. 12 is inserted directly into the rivet shank 96 and comprises a plurality of spreader arms 104, which after penetrating the rivet shank 96 spread apart from one another and prevent the signalling device 94 from moving out. The additional signalling device 94 illustrated in FIG. 13 carries a nut 108 on a threaded shank 106. The warning device 94, having been passed through the rivet shank 96, is secured by means of the nut 108.

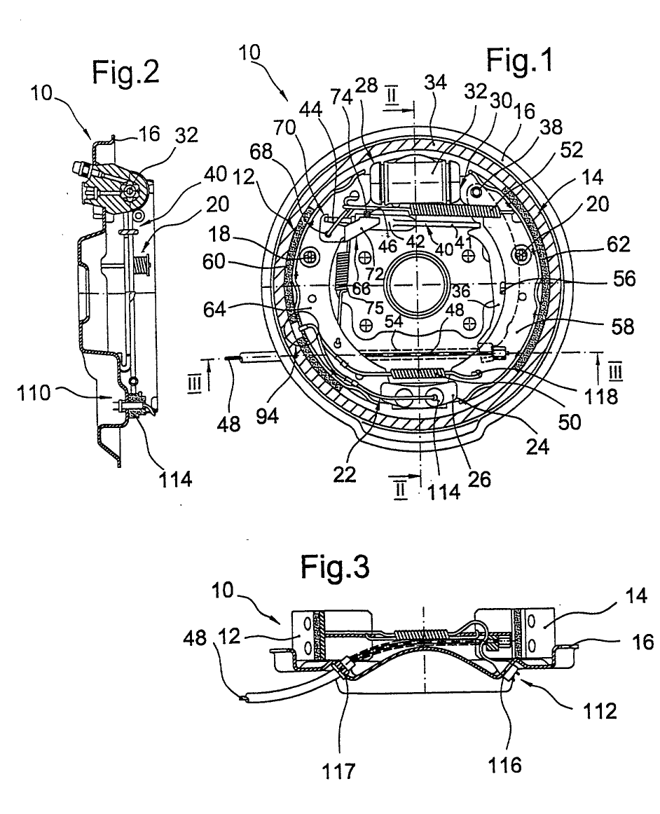

The electric conductors and/or lines leading to the wire loop 98 and accordingly also the electric line 86 of the switch 79 lead to plug-in connectors 110 and 112 which, as is shown in FIGS. 1 to 3, are fastened in a tubular rivet 114 of the dome 26 and in an opening 116 in the anchor plate 16, which opening is symmetrical relative to an opening 117 for fastening the hand brake cable 48 to the anchor plate 16. The lines further extend through the top and bottom brake shoe retracting springs 50 and 52 as well as through an opening 118 of the web plate 58.

As the illustrated forms of construction of the signalling device 79 may be used practically without modifications in existing standard brakes, the adjusting apparatus 40 is also suitable for the retrofitting of already supplied drum brakes.

In accordance with the provisions of the patent statues, the principle and mode of operation of this invention have been described and illustrated in its preferred embodiments. However, it must be understood that the invention may be practiced otherwise than as specifically explained and illustrated without departing from the scope or spirit of the attached claims.

What is claimed is:

1. An automatic drum brake adjusting apparatus for compensating for friction lining and drum wear comprising:
a signalling device, which supplies a signal dependent upon an adjusting travel, wherein the adjusting travel is generated by a variable length adjusting strut which includes a pressure sleeve and a threaded rod which is disposed in the pressure sleeve and is displaceable by means of a pinion out of the pressure sleeve, the threaded rod after a predetermined adjusting travel actuates a switch disposed in the pressure sleeve; wherein the switch includes an electrically conducting contact pin which is guided displaceably in a sleeve and which up to achieving the predetermined adjusting travel is resiliently biased towards the threaded rod and after achieving the predetermined adjusting travel comes into abutment with a stop formed on the sleeve thereby interrupting the contact between the contact pin and the threaded rod.

2. The automatic drum brake adjusting apparatus according to claim 1 wherein the signal is brought to the attention of a vehicle driver visually and/or acoustically.

3. The automatic drum brake adjusting apparatus according to claim 1 wherein a change of the signal in predetermined periods of time is evaluated.

4. A drum brake including an automatic drum brake adjusting apparatus according to claim 1.

5. The drum brake according to claim 4 wherein at least one brake shoe of the drum brake is provided with an additional signalling device for indicating a worn friction lining thereof.

6. The drum brake according to claim 4 wherein a conductor leading to the additional signalling device extends inside a brake shoe resetting spring.

7. The drum brake according to claim 4 wherein a conductor leading to the additional signalling device extends through a first opening in an anchor plate of the drum brake, which opening is disposed axially symmetrically relative to a second opening, which is provided for penetration of a hand brake cable, wherein a component of a plug-in connector is fastened in the first opening.

8. The drum brake according to claim 7 wherein the conductor leading to the additional signalling device extends through an opening in a dome of the anchor plate, wherein a component of a plug-in connector is fastened in the dome opening by a tubular rivet.

9. The drum brake according to claim 4 wherein a conductor leading to the signalling device is closed-circuit-protected.

10. The drum brake according to claim 5 wherein the additional signalling device is fastened to the brake shoe by one of a lock washer, spreader arms or a lock nut.
